(19) United States
(12) Patent Application Publication
(10) Pub. No.: US 2024/0021348 A1
(43) Pub. Date: Jan. 18, 2024

(54) PERMANENT MAGNET AND ROTARY ELECTRIC MACHINE

(71) Applicant: KABUSHIKI KAISHA TOSHIBA, Tokyo (JP)

(72) Inventors: Masaya Hagiwara, Yokohama Kanagawa (JP); Shinya Sakurada, Saitama Saitama (JP)

(21) Appl. No.: 18/177,162

(22) Filed: Mar. 2, 2023

(30) Foreign Application Priority Data
May 31, 2022 (JP) 2022-088778

(51) Int. Cl. H01F 1/055; H02K 1/02; H02K 1/27; H02K 7/18

(52) U.S. Cl. CPC H01F 1/055; H02K 7/1823; H02K 1/27; H02K 1/02

(57) ABSTRACT

A permanent magnet is represented by a composition formula 1: RₓNb_{y}BₜM_{100-x-y-t}. R is at least one element selected from the group consisting of rare-earth elements, M is at least one element selected from the group consisting of Fe and Co, x is a number satisfying 4.0<x≤11.0 atomic %, y is a number satisfying 0≤y≤6.5 atomic %, and t is a number satisfying 0≤t<12.0 atomic %. The permanent magnet includes a main phase having a TbCu₇ crystal phase. A density of the permanent magnet is 7.00 g/cm³ or more.

### CROSS-REFERENCE TO RELATED APPLICATIONS

This application is based upon and claims the benefit of priority from Japanese Patent Application No. 2022-088778, filed on May 31, 2022; the entire contents of which are incorporated herein by reference.

### FIELD

Embodiments relate to a permanent magnet and a rotary electric machine.

### BACKGROUND

Permanent magnets are used for products in a wide field including, for example, rotary electric machines such as a motor and a generator, electrical apparatuses such as a speaker and a measuring device, and vehicles such as an automobile and a railroad vehicle. In recent years, downsizing and higher efficiency of the products have been demanded, and thus high-performance permanent magnets with high magnetization and high coercive force have been desired.

Known examples of high-performance permanent magnets include rare-earth magnets such as Sm—Co based magnets and Nd—Fe—B based magnets. Fe and Co contribute an increase of saturation magnetization of these magnets. These magnets contain rare-earth elements such as Nd and Sm, which achieves a large magnetic anisotropy that is derived from behavior of 4f electrons of the rare-earth elements in a crystal field. This achieves a large coercive force of the magnets.

### BRIEF DESCRIPTION OF THE DRAWINGS

FIG. 1 is a view illustrating an example of a permanent magnet motor.

FIG. 2 is a view illustrating an example of a variable magnetic flux motor.

FIG. 3 is a view illustrating an example of a generator.

FIG. 4 is a schematic view illustrating a configuration example of a railway vehicle.

FIG. 5 is a schematic view illustrating a configuration example of an automobile.

### DETAILED DESCRIPTION

A permanent magnet is represented by a composition formula 1: RₓNb_{y}BₜM_{100-x-y-t}. R is at least one element selected from the group consisting of rare-earth elements, M is at least one element selected from the group consisting of Fe and Co, x is a number satisfying 4.0<x≤11.0 atomic %, y is a number satisfying 0≤y≤6.5 atomic %, and t is a number satisfying 0≤t<12.0 atomic %. The permanent magnet includes a main phase having a TbCu₇ crystal phase. A density of the permanent magnet is 7.00 g/cm³ or more.

Hereinafter, embodiments will be explained with reference to the drawings. The drawings are schematic, and for example, a relation between a thickness and a plane dimension, a ratio of thicknesses of the respective layers, and the like are sometimes different from actual ones. Moreover, in the embodiments, substantially the same components are denoted by the same reference signs, and explanations thereof are omitted.

### First Embodiment

A permanent magnet of an embodiment contains a rare-earth element, an M element (M is at least one element selected from the group consisting of Fe and Co), a niobium (Nb) element, and a boron (B) element. The permanent magnet includes a metal structure whose main phase is a crystal phase containing the M element with high concentration. An increase of the M element concentration in the main phase, can improve saturation magnetization. The main phase has the highest volume occupancy ratio among respective crystal phases and amorphous phases in a magnet material. The magnet material may also include a sub phase. Examples of the sub phases include a crystal phase between crystal grains of the main phase, a microcrystalline phase, and an impurity phase. Examples of a crystal phase having high concentration of the M element, include a TbCu₇ crystal phase.

The addition of the Nb and B elements with the rare-earth element and the M element, can enhance the amorphous formability to increase the coercive force. One of applications of the permanent magnet is a motor. Recent years have seen increasing demands for the reduction in size and higher speed of motors, leading to an increasing requirement for a heat resistance improvement of magnets. The improvement of the heat resistance is to improve the coercive force.

The formation of fine crystal grains is one of effective methods for achieving the high coercive force of the permanent magnet having high magnetic anisotropy. Accordingly, the main phase preferably has a microcrystal. The microcrystal can be formed by forming an amorphous ribbon using a liquid quenching method, forming a permanent magnet using the amorphous ribbon, and preforming proper heat treatment to the magnet and thus cause precipitation and growth of the crystal grains of the magnet.

The formation of the fine main phase with high magnetic anisotropy causes each crystal grain to be in a single-domain state easily to prevent forming reverse domain and domain wall propagation, resulting in the achievement of high coercive force of the magnet. The decrease of the coercive force is caused by that the crystal grain size is excessively small or that it is excessively large. Therefore, an average crystal grain size in the main phase is preferably 0.1 nm or more and 100 nm or less, more preferably 0.5 nm or more and 80 nm or less, still more preferably 1 nm or more and 60 nm or less, and yet more preferably 3 nm or more and 50 nm or less. In addition, a squareness ratio of the magnet can be improved by narrowing a grain size distribution in the main phase.

The grain boundary phase may be made of a non-magnetic grain boundary phase or a weak magnetic grain boundary phase. This can disconnect magnetic coupling between the crystal grains to enhance an effect of preventing the reverse domain generation and the domain wall propagation, resulting in enabling the improvement in coercive force. When the grain boundary phase is formed to disconnect the magnetic coupling between crystal grains, the magnet prevents the reverse domain generation and the domain wall propagation to achieve the high coercive force even if its crystal grain size is large.

The formation of the magnet is to control respective addition amounts of the rare-earth element, the M element, the Nb element, and the B element in order to increase the coercive force. The permanent magnet of the embodiment is represented by, for example, a composition formula 1: RₓNb_{y}BₜM_{100-x-y-t}. The permanent magnet may contain inevitable impurities.

The R element is a rare-earth element, and is capable of imparting high magnetic anisotropy and thus high coercive force to the permanent magnet. Concretely, the R element is at least one element selected from the group consisting of yttrium (Y), lanthanum (La), cerium (Ce), praseodymium (Pr), neodymium (Nd), promethium (Pr), samarium (Sm), europium (Eu), gadolinium (Gd), terbium (Tb), dysprosium (Dy), holmium (Ho), erbium (Er), thulium (Tm), ytterbium (Yb), and lutetium (Lu), and is especially preferably Sm. For example, when the R element is composed of a plurality of elements including Sm, the Sm concentration of 50 atomic % or more of all elements capable of being applied as the R element, can increase the performance such as the coercive force of the permanent magnet.

The addition amount x of the R element is preferably a number satisfying, for example, 4.0<x≤11.0 atomic %. x being excessively small or excessively large results in the precipitation of hetero-phase to reduce the coercive force. The addition amount x of the R element is more preferably a number satisfying 4.5≤x≤9.0 atomic %, still more preferably a number satisfying 5.0≤x≤8.0 atomic %, and yet more preferably a number satisfying 6.0≤x≤7.5 atomic %.

The Nb element is effective for stabilizing the crystal phase containing the M element with high concentration. Further, it is effective for promoting amorphization. When the addition amount y of the Nb element is excessively increased, saturation magnetization is reduced. The addition amount y of the Nb element is properly controlled to enable increasing the performance such as the coercive force of the permanent magnet. The addition amount y of the Nb element is preferably a number satisfying 0≤y≤6.5 atomic %, more preferably a number satisfying 0.5≤y≤5.0 atomic %, still more preferably a number satisfying 1.0≤y≤4.0 atomic %, and yet more preferably a number satisfying 1.5≤y≤3.5 atomic %.

50 atomic % or less of the Nb element may be replaced with at least one element selected from the group consisting of zirconium (Zr), hafnium (Hf), and tantalum (Ta). The Zr element, the Ta element, and the Hf element are elements effective for stabilizing the crystal phase and for amorphization. 50 atomic % or less of the Nb element may be replaced with at least one element selected from the group consisting of Zr, Hf, Ta, and Ti.

The M element is at least one element selected from the group consisting of Fe and Co, and is responsible for high saturation magnetization of the permanent magnet. 50 atomic % or more of the M element is preferably Fe, because Fe is higher than Co in magnetization. Co in the M element can increase the Curie temperature of the permanent magnet to prevent a reduction in saturation magnetization in high-temperature regions. Further, little Co in the M element achieves higher saturation magnetization than the M element consisting of Fe only. On the other hand, an increase of a ratio of Co lowers magnetic anisotropy. The excessively high ratio of Co may reduce saturation magnetization. Accordingly, the ratio of Fe and Co is properly controlled to enables the achievement of high saturation magnetization, high anisotropic magnetic field, and high Curie temperature. When M in the composition formula 1 is represented by (Fe₁₋ᵥCoᵥ), a preferable value of v is 0.01≤v<0.7, more preferably 0.01≤v<0.5, and still more preferably 0.01≤v≤0.3. 20 atomic % or less of the M element may be replaced with at least one element selected from the group consisting of nickel (Ni), copper (Cu), vanadium (V), chromium (Cr), manganese (Mn), aluminum (Al), silicon (Si), gallium (Ga), tantalum (Ta), tungsten (W), titanium (Ti), and molybdenum (Mo). Examples of contributions of the elements include growth of crystal grains constituting the main phase.

The B element is effective for promoting amorphization. The addition amount t of the B element is properly controlled to enable forming an amorphous ribbon by a method with high industrial productivity such as a single-roll quenching method. The addition amount t of the B element is preferably a number satisfying, for example, 0≤t<12.0 atomic %. When the addition amount of the B element is excessively large, a hetero-phase such as an R₂Fe₁₄B phase is likely to be formed to reduce the coercive force. When the addition amount of the B element is excessively large, saturation magnetization is reduced. The amorphization is possible even though the B element is not substantially contained, but a single-roll method may reduce the industrial productivity because the single-roll method needs to increase a roll peripheral speed to increase a cooling rate. The addition amount t of the B element is more preferably a number satisfying 1.0≤t≤11.0 atomic %, still more preferably a number satisfying 2.0≤t≤10.8 atomic %, and yet more preferably a number satisfying 5.0≤t≤10.5 atomic %.

A part of the R element may be replaced with a Y element. The permanent magnet is represented by, for example, a composition formula 2: (R₁₋ᵤYᵤ)ₓNb_{y}BₜM_{100-x-y-t}. The permanent magnet may contain inevitable impurities. As the explanation regarding the R element, the Nb element, the B element, and the M element, the explanation can be cited appropriately. 1 atomic % or more and 50 atomic % or less of the R element may be Y.

The Y element is effective for stabilizing the crystal phase containing the M element with high concentration, for example, a ThMn₁₂ crystal phase or a TbCu₇ crystal phase. In the crystal phase containing the M element with high concentration, the higher the M element concentration, the higher the saturation magnetization, which can increase the magnetic properties. However, when the M element concentration becomes high, a crystal structure becomes unstable, which causes the decomposition of the main phase and the precipitation of an α-Fe phase or an α-(Fe, Co) phase, thereby decreasing the coercive force. In contrast with this, by replacing a part of the R element with the Y element, it is possible to increase the stability of the crystal phase containing the M element with high concentration, thereby further increasing the M element concentration. This can achieve both high coercive force and high magnetization. The addition amount u of the Y element is preferably a number satisfying 0.01≤u≤0.5. u being excessively small results in the small effect of stabilization, and u being excessively large results in the reduction in magnetic anisotropy, which reduces the coercive force. u is more preferably a number satisfying 0.02≤u≤0.4, and is still more preferably a number satisfying 0.05≤u≤0.3.

The permanent magnet of the embodiment may have a ThMn₁₂ crystal phase of a main phase as a crystal phase having a high concentration of the M element. The permanent magnet is represented by, for example, a composition formula 3: RₓNb_{y}BₜM_{100-x-y-t}, in which x is a number satisfying 4.0<x≤11.0 atomic %, y is a number satisfying 0<y≤6.5 atomic %, and t is a number satisfying 0≤t<12.0 atomic %. The permanent magnet may contain inevitable impurities. As the explanation regarding the R element, the Nb element, the B element, and the M element, the explanation can be cited appropriately.

The permanent magnet of the embodiment may further contain an A element. The A element is at least one element selected from the group consisting of nitrogen (N), carbon (C), hydrogen (H), and phosphorus (P). The A element has a function of entering a crystal lattice to cause at least one of enlargement of the crystal lattice and change in electronic structure, for example. This can change the Curie temperature, the magnetic anisotropy, and the saturation magnetization. The A element does not necessarily have to be added except for the inevitable impurities.

The permanent magnet of the embodiment has a density of 7.0 g/cm³ or more. An increase of the density can increase residual magnetization of the permanent magnet. Further, this increase corrosion resistance and mechanical strength as well. The density is more preferably 7.2 g/cm³ or more, and still more preferably 7.5 g/cm³ or more. Although an upper limit of the density is not limited in particular, it is 7.9 g/cm³ or less, for example.

The permanent magnet of the embodiment is preferably a sintered compact. A bond magnet requires a large mold pressure for increasing a density, which is industrially difficult. Further, if a binder is reduced for increasing a filling factor of the magnet material, the strength of the permanent magnet is reduced.

The permanent magnet of the embodiment has a high density while including the crystal phase containing the M element with high concentration such as the TbCu₇ crystal phase, for example, as its main phase. This can achieve both high coercive force and high residual magnetization.

The permanent magnet of the embodiment has a small proportion of an α-Fe phase or an α-(Fe, Co) phase, and an R₂Fe₁₄B phase or an R₂(Fe, Co)₁₄B phase. A proportion of at least one phase selected from the phases is 10 volume % or less. This can increase the coercive force. The proportion is more preferably 5 volume % or less, and still more preferably 1 volume % or less.

The permanent magnet of the embodiment has a filling factor of 85.0% or more and 99.9% or less. An increase of the filling factor can increase the residual magnetization. Further, this can also increase the corrosion resistance and the mechanical strength. The filling factor is more preferably 90.0% or more, and still more preferably 95.0% or more.

Specific coercive force of the permanent magnet of the embodiment is 300 kA/m or more and 2500 kA/m or less. In order to enhance heat resistance, the specific coercive force is more preferably 500 kA/m or more and 2500 kA/m or less, still more preferably 600 kA/m or more and 2500 kA/m or less, and yet more preferably 650 kA/m or more and 2500 kA/m or less.

The residual magnetization of the permanent magnet of the embodiment is 0.8 T or more and 1.6 T or less. The higher residual magnetization is more effective in the reduction in size and the like of the motor. The residual magnetization is preferably 0.85 T or more and 1.6 T or less, and more preferably 0.9 T or more and 1.6 T or less.

The composition of the permanent magnet can be measured using, for example, high-frequency ICP-AES (Inductively Coupled Plasma-Atomic Emission Spectroscopy), SEM-EDX (Scanning Electron Microscope-Energy Dispersive X-ray Spectroscopy), TEM-EDX (Transmission Electron Microscope-Energy Dispersive X-ray Spectroscopy), STEM-EDX (Scanning Transmission Electron Microscope-Energy Dispersive X-ray Spectroscopy), or the like.

Volume ratios of each phase of the metal structure are comprehensively determined using, for example, both observation with an electron microscope or an optical microscope and an X-ray diffraction analysis or the like, and they can be determined by an areal analysis method of a SEM image obtained by photographing a cross section of the permanent magnet. As the cross section of the permanent magnet, a cross section of a substantially center part of a surface having the largest area in a sample is used. In SEM, for example, a region of 100 ∞m×200 μm or more and 300 μm×500 μm or less is observed with a magnification of 500 times. The observations are performed at 10 locations or more that do not overlap with each other, an average value of values of calculated area ratios in respective images is determined where a maximum value and a minimum value are excluded, and this value is set as a volume ratio of each phase. The total amount of hetero-phases is represented by S_{Fe, Co}/Sₜₒₜₐₗ×100, in which Sₜₒₜₐₗ is an area of SEM image and S_{Fe, Co} is the total sum of areas of hetero-phases.

An average grain size of the main phase can be determined as follows. A given grain is selected from main phase crystal grains that are specified in a cross section of the permanent magnet using STEM-EDX, and the longest straight line A whose ends are in contact with other phases is drawn on the selected grain. Next, a straight line B that is perpendicular to the straight line A at the midpoint of the straight line A and whose ends are in contact with other phases is drawn. An average length of the straight line A and the straight line B is defined as a diameter D in the phase. D in one given phase or more is determined in the procedure. Such D is calculated in five fields of view per sample, and an average of D's is defined as the diameter (D) in the phase. As the cross section of the permanent magnet, a cross section of a substantially center part of a surface having the largest area in a sample is used.

The density of the permanent magnet can be determined from a dimension and weight of a mold. These determination may be performed after grinding or the like the permanent magnet in order to further increase a dimensional accuracy. Alternatively, the density may be determined using the Archimedean method.

The filling factor of the permanent magnet can be determined by, for example, an areal analysis method of a SEM image obtained by photographing a cross section of the permanent magnet. As the cross section of the permanent magnet, a cross section of a substantially center part of a surface having the largest area in a sample is used. The observation of SEM, for example, can be performed at a region of 100 μm×200 μm or more and 300 μm×500 μm or less with a magnification of 500 times. The observations are performed at 10 locations or more that do not overlap with each other, an average value of values of calculated area ratios in individual images is determined where a maximum value and a minimum value are excluded, and this value is set as a volume ratio of each phase. The filling factor is represented by S_{mag}/Sₜₒₜₐₗ×100, in which Sₜₒₜₐₗ is an area of SEM image and S_{mag} is the total sum of area of the magnet material.

The magnetic properties such as the coercive force and the magnetization of the permanent magnet are calculated using, for example, a direct-current fluxmeter (BH tracer) or a VSM (Vibrating Sample Magnetometer).

Next, an example of a manufacturing method of the permanent magnet of the embodiment will be described. First, an alloy containing predetermined elements necessary for the permanent magnet is manufactured. The alloy can be manufactured using, for example, an arc melting method, a high-frequency melting method, a mold casting method, a mechanical alloying method, a mechanical grinding method, a gas atomization method, a reduction diffusion method, or the like.

The alloy is melted and quenched. Consequently, the alloy is amorphized. The molten alloy is cooled using, for example, a liquid quenching method (melt-spinning method). In the liquid quenching method, the alloy molten metal is jetted to a roll rotating at a high speed. The roll may be either of a single-roll type or of a twin-roll type and as its material, copper, a copper alloy such as copper beryllium, or the like is mainly used. The control of the amount of the jetted molten metal and the peripheral speed of the rotating roll, can control the cooling rate of the molten metal. The control of the composition and the cooling rate can control the degree of the amorphization of the alloy. The quenching process need not be executed when the alloy can be sufficiently amorphized using the gas atomization method or the like in the alloy production.

The amorphized alloy or amorphized alloy ribbon is milled. The milling method can be selected from various milling methods. The milling can be performed using a mill such as a cutter mill, a roller mill, a jet mill, or a ball mill, for example. The milling may also be performed using a mortar. An average length of the permanent magnet is preferably 1 μm or more and 1000 μm (1 mm) or less. The excessively small grain size may reduce the saturation magnetization of the permanent magnet. The excessively large grain size may increase a residual ratio of holes in compression molding to reduce the saturation magnetization of the permanent magnet. The average length is more preferably 5 μm or more and 500 μm or less, and still more preferably 10 μm or more and 150 μm or less. The average length of the magnet material can be controlled by, for example, sieving. The average length may be controlled by adjusting milling conditions such as a milling time and a screen diameter of various milling machines such as the cutter mill and the roller mill. The average length can be defined by determining longer-side direction lengths of 50 or more pieces of powder from a SEM image to obtain an average value thereof, for example.

The powder fills a metal mold, and then pressure sintering is performed through hot pressing to form a sintered compact. A pressure to be applied is preferably 0.5 ton/cm² or more and 20 ton/cm² or less. The excessively low pressure may cause the insufficient densification. The excessively high pressure may prevent industrially manufacturing the magnet easily. The applied pressure is more preferably 1.0 ton/cm² or more and 15 ton/cm² or less, and still more preferably 5.0 ton/cm² or more and 13 ton/cm² or less.

The metal mold is filled with the powder, and then may receive a magnetic field. This can improve the orientation of powder.

A temperature during the pressure sintering is, for example, 500° C. or more and 1000° C. or less. The excessively low temperature may lower the effect of the densification. The excessively high temperature decompose the main phase to increase the proportion of the α-Fe phase or the α-(Fe, Co) phase, and the R₂Fe₁₄B phase or the R₂(Fe, Co)₁₄B phase. The temperature is more preferably 600° C. or more and 800° C. or less, and still more preferably 650° C. or more and 750° C. or less.

A retention time during the pressure sintering is, for example, 1 minute or more and 10 hours or less. The excessively short retention time may lower the effect of the densification. The excessively long retention time may promote the decomposition of main phase and the increase in crystal grain size to decrease the coercive force. The retention time is more preferably 10 minutes or more and 5 hours or less, and still more preferably 15 minutes or more and 1 hour or less.

The hot pressing may be replaced with hot isostatic pressing (HIP) or spark plasma sintering (SPS). Each method can be use this employ optimum condition for the applied pressure, the heating temperature, and the retention time, in accordance with each method.

The sintered compact formed by the pressure sintering may be subjected to heat treatment. This treatment can promote the crystallization of the main phase to form a metal structure including the main phase having microcrystals. An example of the heating can be executed at a temperature of 500° C. or more and 1000° C. or less for 5 minutes or more and 300 hours or less under an inert atmosphere, for example, in argon (Ar) or in a vacuum.

The excessively low temperature may cause the insufficient crystallization and the insufficient uniformity to lower the coercive force. The excessively high temperature may cause the decomposition or the like of the main phase to form a hetero-phase, and thus lower the coercive force and the squareness. The heating temperature is more preferably 520° C. or more and 800° C. or less, still more preferably 540° C. or more and 700° C. or less, and yet more preferably 550° C. or more and 650° C. or less, for example. The excessively short heating time may cause the insufficient crystallization and the insufficient uniformity to lower the coercive force.

When the crystal phase of the main phase is the ThMn₁₂ crystal phase, for example, the heating temperature is more preferably 600° C. or more and 1000° C. or less, and still more preferably 700° C. or more and 1000° C. or less.

The excessively long heating time may cause the decomposition or the like of the main phase to form a hetero-phase, and thus lower the coercive force and the squareness. The heating time is preferably 15 minutes or more and 150 hours or less, more preferably minutes or more and 120 hours or less, still more preferably 1 hour or more and 120 hours or less, yet more preferably 2 hours or more and 100 hours or less, and yet more preferably 3 hours or more and 80 hours or less.

The sintered compact is heated as mentioned above, and then the sintered compact is cooled by a method such as furnace cooling, water quenching, gas quenching, or oil quenching. The heat treatment need not be executed when the sintered compact can be sufficiently crystallized by the pressure sintering.

The sintered compact may also be subjected to hot working. The hot working can orient a c-axis of crystal grain. The hot working can be executed by, for example, disposing the sintered compact in a metal mold whose dimension is larger than that of the sintered compact in accordance with a working ratio, and performing pressure heating treatment. For instance, a pressure to be applied is 0.5 ton/cm² or more and 20 ton/cm² or less, a temperature during pressure sintering is 500° C. or more and 1000° C. or less, and a retention time during the pressure sintering is 1 minute or more and 10 hours or less.

The A element may be caused to enter the sintered compact. The A element is preferably entered into the alloy powder before the pressure sintering. When the A element is nitrogen, the N element can be entered into the alloy by heating the alloy at a temperature of 200° C. or more and 700° C. or less for 1 hour or more and 100 hours or less in an atmosphere of nitrogen gas, an ammonia gas, or the like with an air pressure of about atm or more and 100 atm or less, to nitride the alloy. When the A element is carbon, the C element can be entered into the alloy by heating the alloy in a temperature range of 300° C. or more and 900° C. or less for 1 hour or more and 100 hours or less in an atmosphere of an acetylene (C₂H₂), methane (CH₄), propane (C₃H₈), or carbon monoxide (CO) gas or a pyrolysis gas of methanol (CH₃OH), with an air pressure of about 0.1 atm or more and 100 atm or less, to carbonize the alloy. When the A element is hydrogen, the H element can be entered into the alloy by heating the alloy in a temperature range of 200° C. or more and 700° C. or less for 1 hour or more and 100 hours or less in an atmosphere of a hydrogen gas, an ammonia gas, or the like with an air pressure of about 0.1 atm or more and 100 atm or less, to hydrogenate the alloy. When the A element is phosphorus, the P element can be entered into the alloy by phosphorizing the alloy.

Through the process, the permanent magnet is manufactured.

### Second Embodiment

The permanent magnet of the first embodiment can be used for various motors and generators. In addition, it can also be used as a stationary magnet or a variable magnet of a variable magnetic flux motor or a variable magnetic flux generator. The various motors and generators are configured using the permanent magnet of the first embodiment. When the permanent magnet of the first embodiment is applied to the variable magnetic flux motor, the techniques disclosed in Japanese Laid-open Patent Publication No. 2008-29148 and Japanese Laid-open Patent Publication No. 2008-43172 can be applied to the configuration of the variable magnetic flux motor and a drive system, for example.

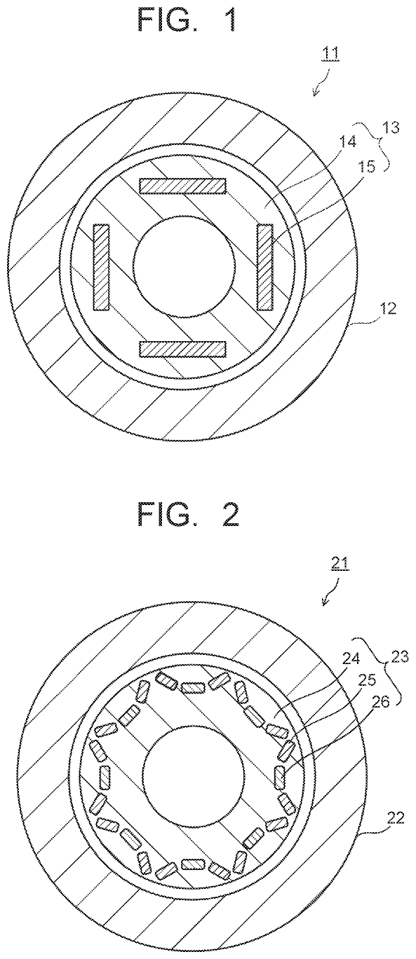

Next, a motor and a generator including the permanent magnet will be explained with reference to the drawings. FIG. 1 is a view illustrating a permanent magnet motor. In a permanent magnet motor 11 illustrated in FIG. 1, a rotor 13 is disposed in a stator 12. In an iron core 14 of the rotor 13, permanent magnets 15 being the permanent magnets of the first embodiment are disposed. Using the permanent magnets of the first embodiment, high efficiency, reduction in size, cost reduction and the like of the permanent magnet motor 11 can be achieved based on properties and the like of the respective permanent magnets. Further, the permanent magnet can also be inserted into a flux barrier portion of a synchronous reluctance motor. This can increase a power factor of the synchronous reluctance motor.

FIG. 2 is a view illustrating a variable magnetic flux motor. In a variable magnetic flux motor 21 illustrated in FIG. 2, a rotor 23 is disposed in a stator 22. In an iron core 24 of the rotor 23, the permanent magnets of the first embodiment are disposed as stationary magnets 25 and variable magnets 26. A magnetic flux density (flux quantum) of the variable magnet 26 is allowed to be variable. The variable magnet 26 is not affected by a Q-axis current but can be magnetized by a D-axis current because a magnetization direction thereof is perpendicular to a Q-axis direction. The rotor 23 is provided with a magnetization winding (not illustrated). There is made the structure in which by passing an electric current from a magnetization circuit to this magnetization winding, its magnetic field acts directly on the variable magnets 26.

According to the permanent magnet of the first embodiment, it is possible to obtain a coercive force suitable for the stationary magnet 25. When the permanent magnet of the first embodiment is applied to the variable magnet 26, it is sufficient that, for example, the coercive force is controlled in a range of 100 kA/m or more and 500 kA/m or less by changing manufacturing conditions. Note that in the variable magnetic flux motor 21 illustrated in FIG. 2, the permanent magnet of the first embodiment can be used for both the stationary magnet 25 and the variable magnet 26, and the permanent magnet of the first embodiment may be used for either of the magnets. Because the variable magnetic flux motor 21 is capable of outputting large torque with a small apparatus size, it is suitable for a motor of a hybrid vehicle, an electric vehicle, or the like required to have a high-output and compact motor.

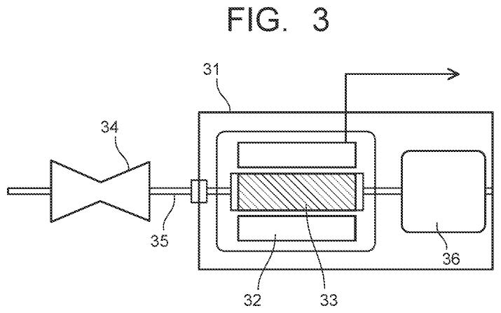

FIG. 3 illustrates a generator. A generator 31 illustrated in FIG. 3 includes a stator 32 using the permanent magnet. A rotor 33 disposed inside the stator 32 is connected via a shaft 35 to a turbine 34 provided at one end of the generator 31. The turbine 34 is rotated by, for example, fluid supplied from the outside. Note that in place of the turbine 34 rotated by the fluid, the shaft 35 can also be rotated by transferring dynamic rotation such as regenerated energy of an automobile. Various publicly-known configurations can be employed for the stator 32 and the rotor 33.

The shaft 35 is in contact with a commutator (not illustrated) disposed on the opposite side to the turbine 34 with respect to the rotor 33, so that an electromotive force generated by a rotation of the rotor 33 is boosted to a system voltage and is transmitted as an output from the generator 31 via an isolated bus and a main transformer (not illustrated). The generator 31 may be either of an ordinary generator and a variable magnetic flux generator. The rotor 33 generates an electrostatic charge by static electricity from the turbine 34 and an axial current accompanying power generation. Therefore, the generator 31 includes a brush 36 for discharging the electrostatic charge of the rotor 33.

As described above, by applying the permanent magnet to the generator, effects such as high efficiency, reduction in size, and cost reduction are obtained.

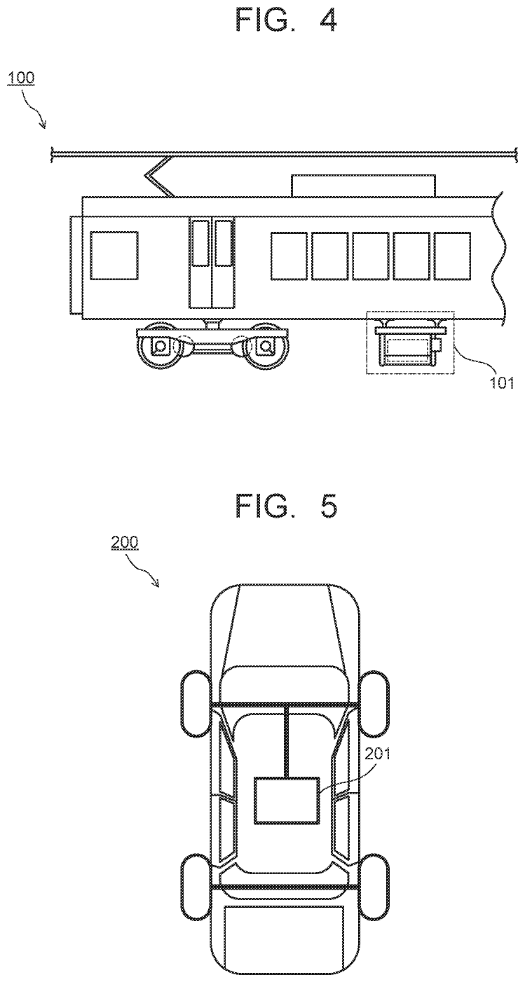

The rotary electric machine may be mounted in, for example, a railway vehicle (one example of the vehicle) to be used for railway traffic. FIG. 4 is a view illustrating one example of a railway vehicle 100 including a rotary electric machine 101. As the rotary electric machine 101, any of the motors in FIGS. 1 and 2, the generator in FIG. 3, and the like described above can be used. When the rotary electric machine is mounted as the rotary electric machine 101, the rotary electric machine 101 may be used as, for example, a motor that outputs driving force using electric power supplied from an overhead wire or electric power supplied from a secondary battery mounted in the railway vehicle 100, or may be used as a generator that converts kinetic energy into electric power and supplies the electric power to various loads in the railway vehicle 100. Using such a high-efficient rotary electric machine as the rotary electric machine of the embodiment allows the railway vehicle to travel in an energy-saving manner.

The rotary electric machine may be mounted in an automobile (another example of the vehicle) such as a hybrid vehicle or an electric vehicle. FIG. 5 is a view illustrating one example of an automobile 200 including a rotary electric machine 201. As the rotary electric machine 201, any of the motors in FIGS. 1 and 2, the generator in FIG. 3, and the like described above can be used. When the rotary electric machine is mounted as the rotary electric machine 201, the rotary electric machine 201 may be used as a motor that outputs driving force of the automobile 200 or a generator that converts kinetic energy when the automobile 200 travels into electric power. In addition, the rotary electric machine may be mounted in, for example, industrial equipment (industrial motor), an air-conditioning apparatus (air conditioner and water heater compressor motor), a wind power generator, or an elevator (hoist).

### EXAMPLES

### Examples 1 to 10

Appropriate amounts of raw materials were weighed to produce alloys using the arc melting method. Next, the alloys were melted, and the obtained molten metals were quenched by the single-roll method, to form quenched alloy ribbons. The alloy ribbons were milled, to form alloy powders with an average length of 100 μm or more and 200 μm or less. After filling a metal mold with each of the alloy powders, pressure sintering was performed through hot pressing in an Ar atmosphere. The heating was performed under an applied pressure of 10 ton/cm² at a temperature of 700° C. for 30 minutes, and then furnace cooling was conducted. Sintered compacts after being subjected to the pressure sintering, were subjected to heat treatment in which they were retained at a temperature of 600° C. for hours in an Ar atmosphere, to form sintered magnets. Compositions of the magnet materials were evaluated using the ICP-AES. Constituent phases of the sintered magnets were evaluated using the XRD. A density of each of the sintered compacts was calculated from a dimension and weight after the processing, and a filling factor and a hetero-phase amount were calculated from a cross-sectional SEM image. Further, the BH tracer was used to evaluate magnetic properties of the permanent magnets. Table 1 shows the evaluation results of the compositions of the magnet materials, crystal phases of main phases, the densities, the filling factors, the hetero-phase amounts, coercive forces, and residual magnetizations.

### Examples 11 to 13

Appropriate amounts of raw materials were weighed to produce alloys using the high-frequency melting method. Next, the alloys were melted, and the obtained molten metals were quenched by the single-roll method, to form quenched alloy ribbons. The alloy ribbons were milled, to form alloy powders with an average length of 100 μm or more and 200 μm or less. After filling a metal mold with each of the alloy powders, pressure sintering was performed through hot pressing in an Ar atmosphere. The heating was performed under an applied pressure of 10 ton/cm² at a temperature of 650° C. for 1 hour, and then furnace cooling was conducted. Sintered compacts after being subjected to the pressure sintering, were subjected to heat treatment in which they were retained at a temperature of 600° C. for 20 hours in an Ar atmosphere, to form sintered magnets. Compositions of the magnet materials were evaluated using the ICP-AES. Constituent phases of the sintered magnets were evaluated using the XRD. A density of each of the sintered compacts was calculated from a dimension and weight after the processing, and a filling factor and a hetero-phase amount were calculated from a cross-sectional SEM image. Further, the BH tracer was used to evaluate magnetic properties of the permanent magnets. Table 1 shows the evaluation results of the compositions of the magnet materials, crystal phases of main phases, the densities, the filling factors, the hetero-phase amounts, coercive forces, and residual magnetizations.

### Example 14

Appropriate amounts of raw materials were weighed to produce an alloy using the high-frequency melting method. Next, the alloy was melted, and the obtained molten metal was quenched by the single-roll method, to form a quenched alloy ribbon. The alloy ribbon was milled, to form an alloy powder with an average length of 100 μm or more and 200 μm or less. After filling a metal mold with the alloy powder, pressure sintering was performed through hot pressing in an Ar atmosphere. The heating was performed under an applied pressure of 15 ton/cm² at a temperature of 600° C. for 5 hours, and then furnace cooling was conducted. A sintered compact after being subjected to the pressure sintering, was subjected to heat treatment in which it was retained at a temperature of 610° C. for 10 hours in an Ar atmosphere, to form a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Example 15

Appropriate amounts of raw materials were weighed to produce an alloy using the high-frequency melting method. Next, the alloy was melted, and the obtained molten metal was quenched by the single-roll method, to form a quenched alloy ribbon. The alloy ribbon was milled, to form an alloy powder with an average length of 200 μm or more and 300 μm or less. After filling a metal mold with the alloy powder, pressure sintering was performed through hot pressing in an Ar atmosphere. The heating was performed under an applied pressure of 8 ton/cm² at a temperature of 750° C. for 15 minutes, and then furnace cooling was conducted. A sintered compact after being subjected to the pressure sintering, was subjected to heat treatment in which it was retained at a temperature of 620° C. for 10 hours in an Ar atmosphere, to form a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Example 16

Appropriate amounts of raw materials were weighed to produce an alloy using the high-frequency melting method. Next, the alloy was melted, and the obtained molten metal was quenched by the single-roll method, to form a quenched alloy ribbon. The alloy ribbon was milled, to form an alloy powder with an average length of 200 μm or more and 300 μm or less. After filling a metal mold with the alloy powder, pressure sintering was performed through hot pressing in an Ar atmosphere. The heating was performed under an applied pressure of 7 ton/cm² at a temperature of 800° C. for 5 minutes, and then furnace cooling was conducted. A sintered compact after being subjected to the pressure sintering, was subjected to heat treatment in which it was retained at a temperature of 640° C. for 10 hours in an Ar atmosphere, to produce a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Examples 17 to 19

Appropriate amounts of raw materials were weighed to produce alloys using the high-frequency melting method. Next, the alloys were melted, and the obtained molten metals were quenched by the single-roll method, to form quenched alloy ribbons. The alloy ribbons were milled, to form alloy powders with an average length of 200 μm or more and 300 μm or less. After filling a metal mold with each of the alloy powders, pressure sintering was performed through hot pressing in an Ar atmosphere. The heating was performed under an applied pressure of 10 ton/cm² at a temperature of 650° C. for 10 hours, and then furnace cooling was conducted, to produce sintered magnets. Compositions of the magnet materials were evaluated using the ICP-AES. Constituent phases of the sintered magnets were evaluated using the XRD. A density of each of the sintered compacts was calculated from a dimension and weight after the processing, and a filling factor and a hetero-phase amount were calculated from a cross-sectional SEM image. Further, the BH tracer was used to evaluate magnetic properties of the permanent magnets. Table 1 shows the evaluation results of the compositions of the magnet materials, crystal phases of main phases, the densities, the filling factors, the hetero-phase amounts, coercive forces, and residual magnetizations.

### Examples 20 and 21

Appropriate amounts of raw materials were weighed to produce alloys using the high-frequency melting method. Next, the alloys were melted, and the obtained molten metals were quenched by the single-roll method, to form quenched alloy ribbons. The alloy ribbons were milled, to form alloy powders with an average length of 200 μm or more and 300 μm or less. After filling a metal mold with each of the alloy powders, pressure sintering was performed through hot pressing in an Ar atmosphere. The heating was performed under an applied pressure of 8 ton/cm² at a temperature of 750° C. for 15 minutes, and then furnace cooling was conducted. Sintered compacts after being subjected to the pressure sintering, were subjected to heat treatment in which they were retained at a temperature of 950° C. for 10 hours in an Ar atmosphere, to produce sintered magnets. Compositions of the magnet materials were evaluated using the ICP-AES. Constituent phases of the sintered magnets were evaluated using the XRD. A density of each of the sintered compacts was calculated from a dimension and weight after the processing, and a filling factor and a hetero-phase amount were calculated from a cross-sectional SEM image. Further, the BH tracer was used to evaluate magnetic properties of the permanent magnets. Table 1 shows the evaluation results of the compositions of the magnet materials, crystal phases of main phases, the densities, the filling factors, the hetero-phase amounts, coercive forces, and residual magnetizations.

### Comparative Example 1

Appropriate amounts of raw materials were weighed to produce an alloy using the arc melting method. Next, the alloy was melted, and the obtained molten metal was quenched by the single-roll method, to form a quenched alloy ribbon. The alloy ribbon was milled, to form an alloy powder with an average length of 100 μm or more and 200 μm or less. After filling a metal mold with the alloy powder, pressure sintering was performed through hot pressing in an Ar atmosphere. The heating was performed under an applied pressure of 12 ton/cm² at a temperature of 450° C. for 5 hours, and then furnace cooling was conducted. A sintered compact after being subjected to the pressure sintering, was subjected to heat treatment in which it was retained at a temperature of 600° C. for 10 hours in an Ar atmosphere, to produce a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Comparative Example 2

Appropriate amounts of raw materials were weighed to produce an alloy using the arc melting method. Next, the alloy was melted, and the obtained molten metal was quenched by the single-roll method, to form a quenched alloy ribbon. The alloy ribbon was milled, to form an alloy powder with an average length of 100 μm or more and 200 μm or less. After filling a metal mold with the alloy powder, pressure sintering was performed through hot pressing in an Ar atmosphere. The heating was performed under an applied pressure of 8 ton/cm² at a temperature of 1100° C. for 5 minutes, and then furnace cooling was conducted. A sintered compact after being subjected to the pressure sintering, was subjected to heat treatment in which it was retained at a temperature of 600° C. for 10 hours in an Ar atmosphere, to produce a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Comparative Example 3

Appropriate amounts of raw materials were weighed to produce an alloy using the arc melting method. Next, the alloy was melted, and the obtained molten metal was quenched by the single-roll method, to form a quenched alloy ribbon. The alloy ribbon was milled, to form an alloy powder with an average length of 100 μm or more and 200 μm or less. After filling a metal mold with the alloy powder, compression molding was performed at a pressure of 10 ton/cm², and then sintering was carried out at an atmospheric pressure under an Ar atmosphere. The sintering was carried out by performing heating at a temperature of 700° C. for 1 hour, and then furnace cooling was conducted. A sintered compact after being subjected to the sintering, was subjected to heat treatment in which it was retained at a temperature of 600° C. for 10 hours in an Ar atmosphere, to produce a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

### Comparative Example 4

Appropriate amounts of raw materials were weighed to produce an alloy using the arc melting method. Next, the alloy was melted, and the obtained molten metal was quenched by the single-roll method, to form a quenched alloy ribbon. The alloy ribbon was milled, to form an alloy powder with an average length of 100 μm or more and 200 μm or less. After filling a metal mold with the alloy powder, compression molding was performed at a pressure of 10 ton/cm², and then sintering was carried out at an atmospheric pressure under an Ar atmosphere. The sintering was carried out by performing heating at a temperature of 1200° C. for 1 hour, and then furnace cooling was conducted. A sintered compact after being subjected to the sintering, was subjected to heat treatment in which it was retained at a temperature of 600° C. for 10 hours in an Ar atmosphere, to produce a sintered magnet. Compositions of the magnet material were evaluated using the ICP-AES. Constituent phases of the sintered magnet were evaluated using the XRD. A density of the sintered compact was calculated from a dimension and weight after the processing, and a filling factor and a hetero-phase amount were calculated from a cross-sectional SEM image. Further, the BH tracer was used to evaluate magnetic properties of the permanent magnet. Table 1 shows the evaluation results of the compositions of the magnet material, a crystal phase of a main phase, the density, the filling factor, the hetero-phase amount, coercive force, and residual magnetization.

TABLE 1

| | | | | | Hetero- | Residual | |
|---|---|---|---|---|---|---|---|
| | | | | Filling | phase | magneti- | Coercive |
| | | | Density | factor | amount | zation | force |
| | Composition | Main phase | (g/cm3) | (%) | (vol. %) | (T) | (kA/m) |
| Exam. 1 | Sm_{6.8}Nb_{1.8}Fe_{66.1}Co_{16.5}B_{8.8} | TbCu₇ crystal phase | 7.7 | 98 | 2 | 0.93 | 590 |
| Exam. 2 | Sm_{6.6}Nb_{3.0}Fe_{64.9}Co_{16.1}Si_{1.3}B_{8.1} | TbCu₇ crystal phase | 7.7 | 98 | 2 | 0.92 | 600 |
| Exam. 3 | Sm_{7.0}Nb_{2.0}Fe_{64.8}Co_{16.1}B_{10.1} | TbCu₇ crystal phase | 7.5 | 96 | 1 | 0.89 | 610 |
| Exam. 4 | Sm_{6.0}Nb_{2.8}Fe_{65.5}Co_{16.2}B_{9.5} | TbCu₇ crystal phase | 7.6 | 97 | 2 | 0.94 | 550 |
| Exam. 5 | Sm_{7.5}Nb_{1.3}Fe_{67.4}Co_{16.2}B_{7.6} | TbCu₇ crystal phase | 7.7 | 98 | 1 | 0.9 | 590 |
| Exam. 6 | Sm_{6.3}Nb_{3.0}Fe_{66.3}Co_{16.6}Si_{0.8}B_{7.0} | TbCu₇ crystal phase | 7.7 | 98 | 1 | 0.91 | 570 |
| Exam. 7 | (Sm_{0.8}Y_{0.2})_{6.0}Nb_{1.2}Fe_{66.1}Co_{16.3}Ti_{1.8}B_{8.6} | TbCu₇ crystal phase | 7.5 | 96 | 2 | 0.9 | 500 |
| Exam. 8 | (Sm_{0.9}Y_{0.1})_{6.7}Nb_{1.9}Fe_{65.4}Co_{16.4}Si_{1.5}B_{8.1} | TbCu₇ crystal phase | 7.7 | 98 | 1 | 0.92 | 580 |
| Exam. 9 | Sm_{7.2}Nb_{2.4}Fe_{65.7}Co_{16.2}Cu_{0.5}B_{8.0} | TbCu₇ crystal phase | 7.4 | 95 | 2 | 0.85 | 480 |
| Exam. 10 | (Sm_{0.85}Y_{0.15})_{6.5}Nb_{2.6}Fe_{65.3}Co_{16.3}Ga_{0.8}B_{8.5} | TbCu₇ crystal phase | 7.4 | 95 | 2 | 0.84 | 500 |
| Exam. 11 | Sm_{6.8}Nb_{1.8}Fe_{66.1}Co_{16.5}B_{8.8} | TbCu₇ crystal phase | 7.6 | 97 | Less than | 0.91 | 650 |
| | | | | | 1 vol % | | |
| Exam. 12 | Sm_{6.6}Nb_{3.0}Fe_{64.9}Co_{16.1}Si_{1.3}B_{8.1} | TbCu₇ crystal phase | 7.6 | 97 | Less than | 0.89 | 660 |
| | | | | | 1 vol % | | |
| Exam. 13 | (Sm_{0.9}Y_{0.1})_{6.7}Nb_{1.9}Fe_{65.4}Co_{16.4}Si_{1.5}B_{8.1} | TbCu₇ crystal phase | 7.7 | 98 | Less than | 0.93 | 620 |
| | | | | | 1 vol % | | |
| Exam. 14 | Sm_{6.8}Nb_{1.8}Fe_{66.1}Co_{16.5}B_{8.8} | TbCu₇ crystal phase | 7.2 | 92 | Less than | 0.83 | 630 |
| | | | | | 1 vol % | | |
| Exam. 15 | Sm_{6.8}Nb_{1.8}Fe_{66.1}Co_{16.5}B_{8.8} | Tb Cu₇ crystal phase | 7.6 | 97 | 4 | 0.85 | 530 |
| Exam. 16 | Sm_{6.8}Nb_{1.8}Fe_{66.1}Co_{16.5}B_{8.8} | TbCu₇ crystal phase | 7.5 | 96 | 7 | 0.84 | 400 |
| Exam. 17 | Sm_{6.8}Nb_{1.8}Fe_{66.1}Co_{16.5}B_{8.8} | TbCu₇ crystal phase | 7.6 | 97 | Less than | 0.93 | 580 |
| | | | | | 1 vol % | | |
| Exam. 18 | Sm_{6.6}Nb_{3.0}Fe_{64.9}Co_{16.1}Si_{1.3}B_{8.1} | TbCu₇ crystal phase | 7.7 | 98 | Less than | 0.92 | 600 |
| | | | | | 1 vol % | | |
| Exam. 19 | (Sm_{0.9}Y_{0.1})_{6.7}Nb_{1.9}Fe_{65.4}Co_{16.4}Si_{1.5}B_{8.1} | TbCu₇ crystal phase | 7.6 | 97 | Less than | 0.92 | 550 |
| | | | | | 1 vol % | | |
| Exam. 20 | (Sm_{0.8}Y_{0.2})_{7.6}Nb_{5.4}Fe_{66.0}Co_{17.5}B_{3.5} | ThMn₁₂ crystal phase | 7.7 | 98 | 1 | 0.86 | 400 |
| Exam. 21 | (Sm_{0.8}Y_{0.2})_{7.6}Nb_{2.7}Fe_{66.0}Co_{17.5}Ti_{2.7}B_{3.5} | ThMn₁₂ crystal phase | 7.7 | 98 | 1 | 0.87 | 350 |
| Comp. | Sm_{6.8}Nb_{1.8}Fe_{66.1}Co_{16.5}B_{8.8} | TbCu₇ crystal phase | 6.6 | 84 | Less than | 0.8 | 610 |
| Exam. 1 | | | | | 1 vol % | | |
| Comp. | Sm_{6.8}Nb_{1.8}Fe_{66.1}Co_{16.5}B_{8.8} | α-(Fe, Co) phase | 7.7 | 98 | 50 vol % | Less than | Less than |
| Exam. 2 | | R₂(Fe, Co)₁₄B phase | | | or more | 0.5 T | 100 kA/m |
| Comp. | Sm_{6.8}Nb_{1.8}Fe_{66.1}Co_{16.5}B_{8.8} | α-(Fe, Co) phase | 6.6 | 84 | 50 vol % | Less than | Less than |
| Exam. 3 | | R₂(Fe, Co)₁₄B phase | | | or more | 0.5 T | 100 kA/m |
| Comp. | Sm_{6.8}Nb_{1.8}Fe_{66.1}Co_{16.5}B_{8.8} | α-(Fe, Co) phase | 7.7 | 98 | 50 vol % | Less than | Less than |
| Exam. 4 | | R₂(Fe, Co)₁₄B phase | | | or more | 0.5 T | 100 kA/m |

As shown in Table 1, each of the permanent magnets of the examples 1 to 19 includes the main phase having the TbCu₇ crystal phase, and the density thereof is 7.0 g/cm³ or more. Further, each of the permanent magnets of the examples 20 and 21 includes the main phase having the Th₂Mn₁₂ crystal phase, and the density thereof is 7.0 g/cm³ or more. Accordingly, each of the permanent magnets of the examples 1 to 21 has high residual magnetization while having high coercive force. On the other hand, each of the permanent magnets of the comparative examples 1 to 4 does not include the main phase having the TbCu₇ crystal phase or it has low density, and thus its coercive force or residual magnetization is apparently lower than that of the examples.

The embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A permanent magnet represented by a composition formula 1:
RₓNb_{y}BₜM_{100-x-y-t}
where R is at least one element selected from the group consisting of rare-earth elements, M is at least one element selected from the group consisting of Fe and Co, x is a number satisfying 4.0<x≤11.0 atomic %, y is a number satisfying 0≤y≤6.5 atomic %, and t is a number satisfying 0≤t<12.0 atomic %,
the permanent magnet comprising
a main phase having a TbCu₇ crystal phase, wherein
a density of the permanent magnet is 7.00 g/cm³ or more.

2. The permanent magnet according to claim 1, wherein
50 atomic % or more of the R element is Sm.

3. The permanent magnet according to claim 1, wherein
1 atomic % or more and 50 atomic % or less of the R element is Y.

4. The permanent magnet according to claim 1, wherein
50 atomic % or less of the Nb element is replaced with at least one element selected from the group consisting of Zr, Hf, and Ta.

5. The permanent magnet according to claim 1, wherein
atomic % or more of the M element is Fe.

6. The permanent magnet according to claim 1, wherein
atomic % or less of the M element is replaced with at least one element selected from the group consisting of Ni, Cu, V, Cr, Mn, Al, Si, Ga, Ta, W, Ti, and Mo.

7. The permanent magnet according to claim 1, wherein
a proportion of at least one phase selected from the group consisting of an α-Fe phase, an α-(Fe, Co) phase, an R₂Fe₁₄B phase, and an R₂(Fe, Co)₁₄B phase is 10 volume % or less.

8. The permanent magnet according to claim 1, wherein
a filling factor of the permanent magnet is 85.0% or more and 99.9% or less.

9. The permanent magnet according to claim 1, wherein
at least one element selected from the group consisting of nitrogen (N), carbon ©, hydrogen (H), and phosphorus (P) is contained.

10. A permanent magnet represented by a composition formula 3:
RₓNb_{y}BₜM_{100-x-y-t}
where R is at least one element selected from the group consisting of rare-earth elements, M is at least one element selected from the group consisting of Fe and Co, x is a number satisfying 4.0<x≤11.0 atomic %, y is a number satisfying 0<y≤6.5 atomic %, and t is a number satisfying 0≤t<12.0 atomic %,
the permanent magnet comprising
a main phase having a ThMn₁₂ crystal phase, wherein
a density of the permanent magnet is 7.00 g/cm³ or more.

11. The permanent magnet according to claim 10, wherein
50 atomic % or more of the R element is Sm.

12. The permanent magnet according to claim 10, wherein
1 atomic % or more and 50 atomic % or less of the R element is Y.

13. The permanent magnet according to claim 10, wherein
50 atomic % or less of the Nb element is replaced with at least one element selected from the group consisting of Zr, Hf, Ta, and Ti.

14. The permanent magnet according to claim 10, wherein
50 atomic % or more of the M element is Fe.

15. The permanent magnet according to claim 10, wherein
atomic % or less of the M element is replaced with at least one element selected from the group consisting of Ni, Cu, V, Cr, Mn, Al, Si, Ga, Ta, W, Ti, and Mo.

16. The permanent magnet according to claim 10, wherein
a proportion of at least one phase selected from the group consisting of an α-Fe phase, an α-(Fe, Co) phase, an R₂Fe₁₄B phase, and an R₂(Fe, Co)₁₄B phase is 10 volume % or less.

17. The permanent magnet according to claim 10, wherein
a filling factor of the permanent magnet is 85.0% or more and 99.9% or less.

18. The permanent magnet according to claim 10, wherein
the permanent magnet contains at least one element selected from the group consisting of nitrogen (N), carbon (C), hydrogen (H), and phosphorus (P).

19. A rotary electric machine, comprising:
a stator; and
a rotor, wherein
the stator or the rotor includes the permanent magnet according to claim 1.

20. The rotary electric machine according to claim 19, wherein
the rotor is connected to a turbine via a shaft.
